(19) United States
(12) Patent Application Publication
(10) Pub. No.: US 2025/0005589 A1
(43) Pub. Date: Jan. 2, 2025

(54) Smart Incident Status Updates

(71) Applicant: PagerDuty, Inc., San Francisco, CA (US)

(72) Inventors: Weiyu Max Li, Clarksburg, MD (US); Leeor Joseph Engel, Toronto (CA)

(21) Appl. No.: 18/475,845

(22) Filed: Sep. 27, 2023

Related U.S. Application Data
(60) Provisional application No. 63/523,686, filed on Jun. 28, 2023.

(51) Int. Cl. G06Q 30/01; G06N 5/022

(52) U.S. Cl. CPC G06Q 30/01; G06N 5/022

(57) ABSTRACT

Incident data associated with an incident are obtained. A set of reportable criteria related to the incident are obtained. A subset of the reportable criteria described in the incident data are identified using one or more classifiers. A summarization request is transmitted to a language model. The summarization request includes the subset of the reportable criteria and the incident data. An incident status report received from the language model in response to the summarization request is transmitted to one or more users.

### CROSS REFERENCE TO RELATED APPLICATION(S)

This application claims priority to U.S. Provisional Patent Application No. 63/523,686, filed Jun. 28, 2023, the entire disclosure of which is incorporated herein by reference.

### TECHNICAL FIELD

This disclosure relates generally to computer operations and more particularly, but not exclusively, to incident status reporting.

### SUMMARY

A first aspect of the disclosed implementations is a method that includes obtaining incident data associated with an incident; obtaining a set of reportable criteria related to the incident; identifying, using one or more classifiers, a subset of the reportable criteria described in the incident data; transmitting a summarization request to a language model, where the summarization request includes the subset of the reportable criteria and the incident data; and transmitting an incident status report received from the language model to one or more users.

A second aspect of the disclosed implementations is a system that includes one or more memories and one or more processors. The one or more processors are configured to execute instructions stored in the memory to obtain incident data associated with an incident; obtain a set of reportable criteria related to the incident; identify, using one or more classifiers, a subset of the reportable criteria described in the incident data; transmit a summarization request to a language model, where the summarization request includes the subset of the reportable criteria and the incident data; and transmit an incident status report received from the language model to one or more users.

A third aspect of the disclosed implementations is a non-transitory computer readable medium that stores instructions operable to cause one or more processors to perform operations that include obtaining incident data associated with an incident; obtaining a set of reportable criteria related to the incident; identifying, using one or more classifiers, a subset of the reportable criteria described in the incident data; transmitting a summarization request to a language model, where the summarization request includes the subset of the reportable criteria and the incident data; and transmitting an incident status report received from the language model to one or more users.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 shows components of one embodiment of a computing environment for event management.

FIG. 2 shows one embodiment of a client computer.

FIG. 3 shows one embodiment of a network computer that may at least partially implement one of the various embodiments.

FIG. 4 illustrates a logical architecture of a system for generating incident status reports.

FIG. 5 is a block diagram of example functionality of a status reporting software.

FIG. 6 illustrates an example of a user interface for causing incident summary reports to be generated.

FIG. 7 illustrates an example of a portion of a user interface of an incident timeline associated with an incident.

FIG. 8 is a flowchart of a technique for determining which reportable criteria are included in incident data.

FIG. 9A illustrates an example of a template of a classification request transmitted to a classifier with respect to a reportable criterion.

FIG. 9B illustrates an example of training data usable with a reportable criterion.

FIG. 10 is a flowchart of a technique 1000 for obtaining incident status reports.

### DETAILED DESCRIPTION

An event management bus (EMB) is a computer system that may be arranged to monitor, manage, or compare the operations of one or more organizations. The EMB may be configured to accept various events that indicate conditions occurring in the one or more organizations. The EMB may be configured to manage several separate organizations at the same time. Briefly, an event can simply be an indication of a state of change to an information technology (IT) service of an organization. An event can be or describe a fact at a moment in time that may consist of a single or a group of correlated conditions that have been monitored and classified into an actionable state. As such, a monitoring tool of an organization may detect a condition in the IT environment (e.g. such as the computing devices, network devices, software applications, etc.) of the organization and transmit a corresponding event to the EMB. Depending on the level of impact (e.g., degradation of a service), if any, to one or more constituents of a managed organization, an event may trigger (e.g., may be, may be classified as, may be converted into) an incident. As such, an incident may be an unplanned disruption or degradation of service.

Non-limiting examples of events may include that a monitored operating system process is not running, that a virtual machine is restarting, that disk space on a certain device is low, that processor utilization on a certain device is higher than a threshold, that a shopping cart service of an e-commerce site is unavailable, that a digital certificate has or is expiring, that a certain web server is returning a 503 error code (indicating that web server is not ready to handle requests), that a customer relationship management (CRM) system is down (e.g., unavailable) such as because it is not responding to ping requests, and so on.

At a high level, an event may be received at an ingestion software of the EMB, accepted by the ingestion software, queued for processing, and then processed. Processing an event can include triggering (e.g., creating, generating, instantiating, etc.) a corresponding alert and a corresponding incident in the EMB, sending a notification of the incident to a responder (i.e., a person, a group of persons, etc.), and/or triggering a response (e.g., a resolution) to the incident. An alert (an alert object) may be created (instantiated) for anything that requires the performance (by a human or an automated task) of an action. Thus, the alert may embody or include the action to be performed.

An incident associated with an alert may or may be used to trigger a notification the responder who can acknowledge (e.g., assume responsibility for resolving) and resolve the incident. An acknowledged incident is an incident that is being worked on but is not yet resolved. The user that acknowledges an incident may be said to claim ownership of the incident, which may halt any established escalation processes. As such, notifications provide a way for responders to acknowledge that they are working on an incident or that the incident has been resolved. The responder may indicate that the responder resolved the incident using an interface (e.g., a graphical user interface) of the EMB.

Incident responders may be required to provide incident status updates to various stakeholders. These stakeholders may include internal colleagues, team members, end-users, executives, external customers, or other stakeholders. These incident status updates are typically dispatched during the lifecycle of an incident—while the underlying issue is ongoing and the incident is unresolved—and also when the incident has been resolved.

Crafting a status update is not a trivial process. It requires the responder to collect and collate historical data pertaining to the incident and distill the key aspects of incident history to date. This process often entails an in-depth review of the incident, an understanding of the prevailing conditions, and the synthesis of crucial aspects of the incident to date. Such a task necessitates a comprehensive understanding of the incident and its impact, as well as strong communication skills to convey the same effectively. The information required to draft incident status updates often resides in disparate IT systems. For example, one IT system may be a system of record that includes a workflow for managing an incident and which the incident responder uses to update the status of the incident; and the incident responder may use one or more other communication tools (email tools, chat tools, incident-specific chat channels in chat tools, etc.) to communicate with others in the process of resolving incidents.

Therefore, responders must gather and assimilate data from these multiple sources while the responders are still working to resolve the incident. This process can be time-consuming and may also heavily rely on the responder's memory and ability to discern essential information amidst a sea of data. The risk of inadvertent omissions is high due to the dispersion of data and the demands of the incident resolution process. The burden of having to create status updates for an incident may also risk distracting from the process of resolving the on-going incident.

Additionally, the inherent challenge of the writing process itself complicates the process further. Conveying technical information in a clear, concise, and comprehensible manner to stakeholders with varying levels of expertise is a complex task. Responders need to adjust their communication style and content to cater to their diverse audience, ranging from highly technical colleagues to non-technical executives or customers. Adding to the complexity is the potential language barrier. Responders might have to communicate in a language that is not their first, which can pose additional challenges in accurately conveying the intricacies of the incident details, particularly when status updates are required during the time pressures of incident resolution. Factors such as cultural nuances, language idioms, and differing communication styles across languages can further complicate s responder's task of generating an incident status report.

Some existing systems may include naïve, automated generation of incident status updates. To illustrate, some systems may simply collect any notes manually entered by an incident responder regarding an incident and transmit those as incident status updates. Such automated generation of status updates produces updates that may be inappropriate for their intended audiences, tend to be too detailed, and include technical jargon that is difficult to comprehend. Moreover, they often fail to capture the nuances of the incident, and the urgency and importance of the issue to the various stakeholders. Furthermore, they do not take into account the need to provide context for the incident and the impact of the incident on the end-users, executives, and external customers, or other stakeholders. As a result, these automated updates can be confusing and misleading, and may not accurately reflect the current state of the incident.

As such, existing systems lack the technical capabilities to collect, collate, and summarize incident data in the form of a status update. Therefore, there is a significant need for tools or techniques that can or can facilitate incident status update drafting therewith streamlining the process, reducing the risk of omissions, and maximizing consistent, high-quality communication across all stakeholder groups.

Smart incident status updates can use generative artificial intelligence to improve the quality of status updates. A two-step process is used to generate incident status reports. In a first step, smart incident status updates may be understood to perform tasks such as: does the incident data (e.g., history) include information related to a particular reporting criterion? In a second step, if the answer is Yes, then a summary of those incident data related to the particular reporting criterion are included in the incident status report. Otherwise, no information relating to the particular reporting criterion is included in the incident status report.

Smart incident status updates as described herein amounts to asking the language model simple, binary questions regarding a corpus of data (e.g., incident data) and then crafting a specific summarization request based on the answers therewith focusing the language model on the most pertinent portions of the corpus of data. As such, a smart incident status update task becomes a summarization task that is constrained by a set of classification tasks, which is simpler than a more complex, and therefore compute intensive, task.

To illustrate, rather than prompting the language model to identify all those sentences and clauses in the corpus of data related to, for example, “severity changes” and prompting the language model to summarize those sentences, smart incident status updates as described herein essentially asks “does the corpus of data discuss severity changes?” and if so, then a summarization request simply asks for a summary of the severity changes.

With smart incident status updates, incident status updates can be automatically generated. Incident status updates can be quickly and accurately drafted and tailored to particular stakeholders, while also providing an accurate representation of the current state of an incident. Sufficiently detailed yet concise summaries of the status of an incident can be generated, including its impact and urgency, without having to manually draft the update. Responders can review and modify the status update before sending it out, thus ensuring that the update is accurate and complete.

Furthermore, the two-stage/multi-prompt algorithm described herein for smart incident status updates facilitates or enables control of what is relevant to provide (e.g., include) in an incident status report. For example, the incident data (from which a status report is to be generated) may include data unrelated to the incident or to the resolution or impact of the incident. To illustrate, a portion of the incident may be retrieved from a chat system and may include messages related to a lunar eclipse (it may have happened that a lunar eclipse occurred as the incident was ongoing). By limiting the status report to pre-selected reportable criteria (explained below), the data related to the lunar eclipse will be excluded or ignored by the summarization task. Furthermore, the techniques described herein for smart incident status updates can mitigate against adversarial security attacks where a hacker might, for example, inject data irrelevant to incident response in the incident data. Such data will be filtered out or ignored based on the reportable criteria.

While the techniques disclosed herein are described in the context of or in relations to incident data that may relate to IT components and services. The disclosure is not so limited. The techniques described herein can be applied to any corpus of data that is to be summarized based on a set of identified, relevant reportable criteria.

The term “organization” or “managed organization” as used herein refers to a business, a company, an association, an enterprise, a confederation, or the like.

The term “event,” as used herein, can refer to one or more outcomes, conditions, or occurrences that may be detected (e.g., observed, identified, noticed, monitored, received, etc.) by an event management bus. An event management bus (which can also be referred to as an event ingestion and processing system) may be configured to monitor various types of events depending on the needs of an industry and/or technology area. For example, IT services may generate events in response to one or more conditions, such as, computers going offline, memory overutilization, CPU overutilization, storage quotas being met or exceeded, applications failing or otherwise becoming unavailable, networking problems (e.g., latency, excess traffic, unexpected lack of traffic, intrusion attempts, or the like), electrical problems (e.g., power outages, voltage fluctuations, or the like), customer service requests, or the like, or combination thereof. An event (e.g., an event object) may be directly created (such as by a human) in the EMB via user interfaces of the EMB.

Events may be provided to the event management bus using one or more messages, emails, telephone calls, library function calls, application programming interface (API) calls, including, any signals provided to an event management bus indicating that an event has occurred. One or more third party and/or external systems may be configured to generate event messages that are provided to the event management bus.

The term “responder,” as used herein, can refer to a person or entity, represented or identified by persons, that may be responsible for responding to an event associated with a monitored application or service. A responder is responsible for responding to one or more notification events. For example, responders may be members of an IT team providing support to employees of a company. Responders may be notified if an event or incident they are responsible for handling at that time is encountered. In some embodiments, a scheduler application may be arranged to associate one or more responders with times that they are responsible for handling particular events (e.g., times when they are on-call to maintain various IT services for a company). A responder that is determined to be responsible for handling a particular event may be referred to as a responsible responder. Responsible responders may be considered to be on-call and/or active during the period of time they are designated by the schedule to be available.

The term “incident” as used herein can refer to a condition or state in the managed networking environments that requires some form of resolution by a person or an automated service. Typically, incidents may be a failure or error that occurs in the operation of a managed network and/or computing environment. One or more events may be associated with one or more incidents. However, not all events are associated with incidents.

The term “incident response” as used herein can refer to the actions, resources, services, messages, notifications, alerts, events, or the like, related to resolving one or more incidents. Accordingly, services that may be impacted by a pending incident, may be added to the incident response associated with the incident. Likewise, resources responsible for supporting or maintaining the services may also be added to the incident response. Further, log entries, journal entries, notes, timelines, task lists, status information, or the like, may be part of an incident response.

The term “notification message,” “notification event,” or “notification” as used herein can refer to a communication provided by an incident management system to a message provider for delivery to one or more responsible resources or responders. A notification event may be used to inform one or more responsible resources that one or more event messages were received. For example, in at least one of the various embodiments, notification messages may be provided to the one or more responsible resources using SMS texts, MMS texts, email, Instant Messages, mobile device push notifications, HTTP requests, voice calls (telephone calls, Voice Over IP calls (VOIP), or the like), library function calls, API calls, URLs, audio alerts, haptic alerts, other signals, or the like, or combination thereof.

The term “team” or “group” as used herein refers to one or more responders that may be jointly responsible for maintaining or supporting one or more services or systems for an organization.

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

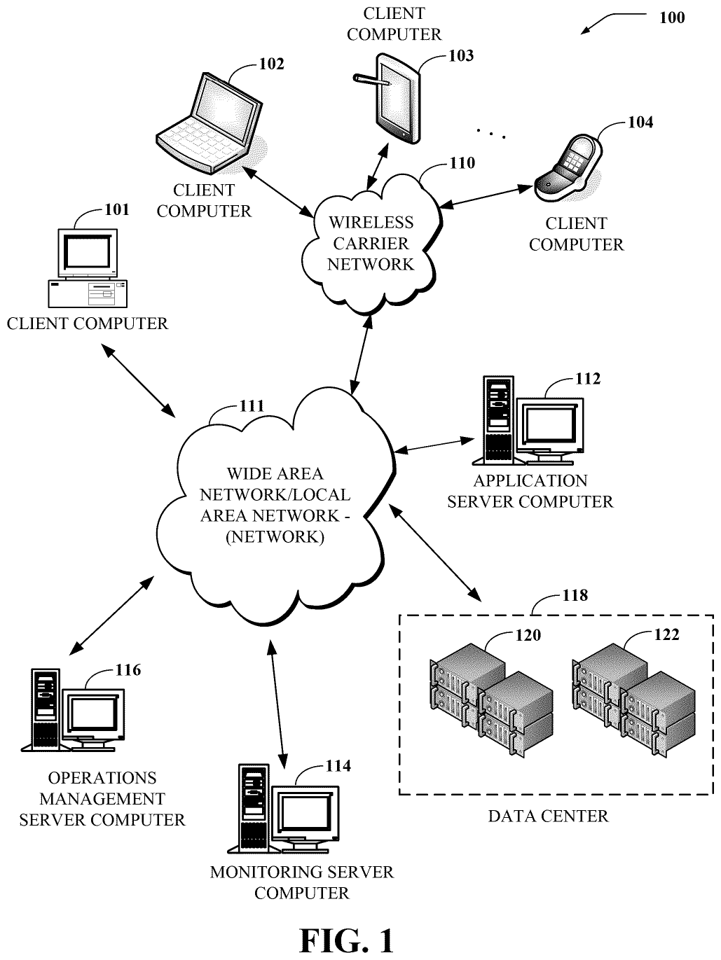

FIG. 1 shows components of one embodiment of a computing environment 100 for event management. Not all the components may be required to practice various embodiments, and variations in the arrangement and type of the components may be made. As shown, the computing environment 100 includes local area networks (LANs)/wide area networks (WANs) (i.e., a network 111), a wireless network 110, client computers 101-104, an application server computer 112, a monitoring server computer 114, and an operations management server computer 116, which may be or may implement an EMB.

Generally, the client computers 102-104 may include virtually any portable computing device capable of receiving and sending a message over a network, such as the network 111, the wireless network 110, or the like. The client computers 102-104 may also be described generally as client computers that are configured to be portable. Thus, the client computers 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDA's), handheld computers, laptop computers, wearable computers, tablet computers, integrated devices combining one or more of the preceding devices, or the like. Likewise, the client computers 102-104 may include Internet-of-Things (IOT) devices as well. Accordingly, the client computers 102-104 typically range widely in terms of capabilities and features. For example, a cell phone may have a numeric keypad and a few lines of monochrome Liquid Crystal Display (LCD) on which only text may be displayed. In another example, a mobile device may have a touch sensitive screen, a stylus, and several lines of color LCD in which both text and graphics may be displayed.

The client computer 101 may include virtually any computing device capable of communicating over a network to send and receive information, including messaging, performing various online actions, or the like. The set of such devices may include devices that typically connect using a wired or wireless communications medium such as personal computers, multiprocessor systems, microprocessor-based or programmable consumer electronics, network Personal Computers (PCs), or the like. In one embodiment, at least some of the client computers 102-104 may operate over wired and/or wireless network. Today, many of these devices include a capability to access and/or otherwise communicate over a network such as the network 111 and/or the wireless network 110. Moreover, the client computers 102-104 may access various computing applications, including a browser, or other web-based application.

In one embodiment, one or more of the client computers 101-104 may be configured to operate within a business or other entity to perform a variety of services for the business or other entity. For example, a client of the client computers 101-104 may be configured to operate as a web server, an accounting server, a production server, an inventory server, or the like. However, the client computers 101-104 are not constrained to these services and may also be employed, for example, as an end-user computing node, in other embodiments. Further, it should be recognized that more or less client computers may be included within a system such as described herein, and embodiments are therefore not constrained by the number or type of client computers employed.

A web-enabled client computer may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, or the like, to display and send a message. In one embodiment, a user of the client computer may employ the browser application to perform various actions over a network.

The client computers 101-104 also may include at least one other client application that is configured to receive and/or send data, operations information, between another computing device. The client application may include a capability to provide requests and/or receive data relating to managing, operating, or configuring the operations management server computer 116.

The wireless network 110 can be configured to couple the client computers 102-104 with network 111. The wireless network 110 may include any of a variety of wireless sub-networks that may further overlay stand-alone ad-hoc networks, or the like, to provide an infrastructure-oriented connection for the client computers 102-104. Such sub-networks may include mesh networks, Wireless LAN (WLAN) networks, cellular networks, or the like.

The wireless network 110 may further include an autonomous system of terminals, gateways, routers, or the like connected by wireless radio links, or the like. These connectors may be configured to move freely and randomly and organize themselves arbitrarily, such that the topology of the wireless network 110 may change rapidly.

The wireless network 110 may further employ a plurality of access technologies including 2nd (2G), 3rd (3G), 4th (4G), 5th (5G) generation radio access for cellular systems, WLAN, Wireless Router (WR) mesh, or the like. Access technologies such as 2G, 3G, 4G, and future access networks may enable wide area coverage for mobile devices, such as the client computers 102-104 with various degrees of mobility. For example, the wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), or the like. The wireless network 110 may include virtually any wireless communication mechanism by which information may travel between the client computers 102-104 and another computing device, network, or the like.

The network 111 can be configured to couple network devices with other computing devices, including, the operations management server computer 116, the monitoring server computer 114, the application server computer 112, the client computer 101, and through the wireless network 110 to the client computers 102-104. The network 111 can be enabled to employ any form of computer readable media for communicating information from one electronic device to another. Also, the network 111 can include the internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. For example, various Internet Protocols (IP), Open Systems Interconnection (OSI) architectures, and/or other communication protocols, architectures, models, and/or standards, may also be employed within the network 111 and the wireless network 110. Furthermore, remote computers and other related electronic devices could be remotely connected to either LANs or WANs via a modem and temporary telephone link. The network 111 can include any communication method by which information may travel between computing devices.

Additionally, communication media typically embodies computer-readable instructions, data structures, program modules, or other transport mechanisms and includes any information delivery media. By way of example, communication media includes wired media such as twisted pair, coaxial cable, fiber optics, wave guides, and other wired media and wireless media such as acoustic, RF, infrared, and other wireless media. Such communication media is distinct from, however, computer-readable devices described in more detail below.

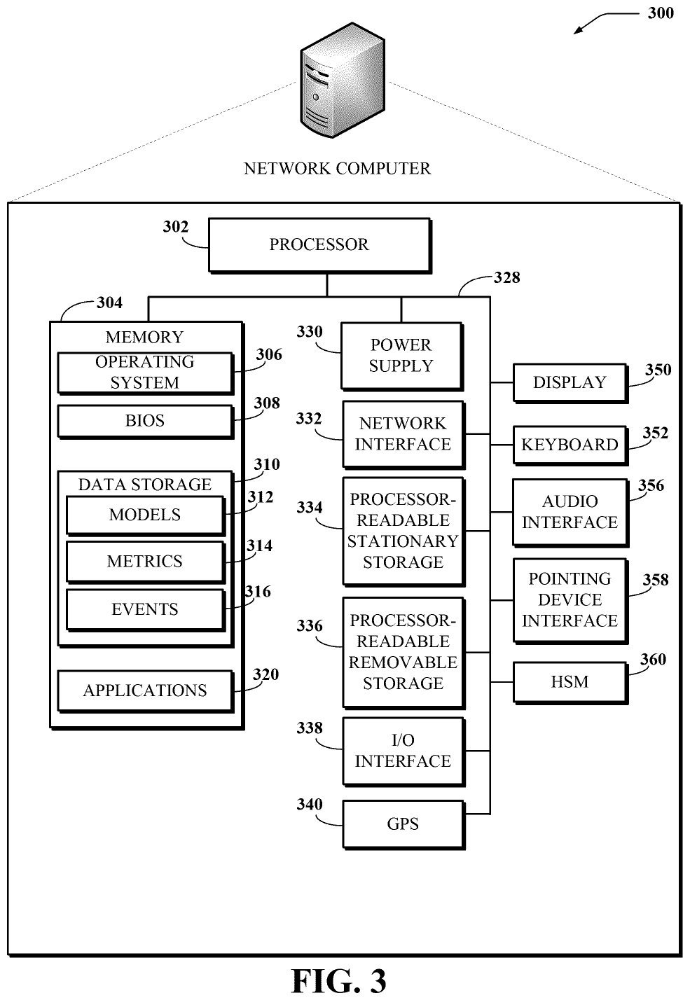

The operations management server computer 116 may include virtually any network computer usable to provide computer operations management services, such as a network computer, as described with respect to FIG. 3. In one embodiment, the operations management server computer 116 employs various techniques for managing the operations of computer operations, networking performance, customer service, customer support, resource schedules and notification policies, event management, or the like. Also, the operations management server computer 116 may be arranged to interface/integrate with one or more external systems such as telephony carriers, email systems, web services, or the like, to perform computer operations management. Further, the operations management server computer 116 may obtain various events and/or performance metrics collected by other systems, such as, the monitoring server computer 114.

In at least one of the various embodiments, the monitoring server computer 114 represents various computers that may be arranged to monitor the performance of computer operations for an entity (e.g., company or enterprise). For example, the monitoring server computer 114 may be arranged to monitor whether applications/systems are operational, network performance, trouble tickets and/or their resolution, or the like. In some embodiments, one or more of the functions of the monitoring server computer 114 may be performed by the operations management server computer 116.

Devices that may operate as the operations management server computer 116 include various network computers, including, but not limited to personal computers, desktop computers, multiprocessor systems, microprocessor-based or programmable consumer electronics, network PCs, server devices, network appliances, or the like. It should be noted that while the operations management server computer 116 is illustrated as a single network computer, the invention is not so limited. Thus, the operations management server computer 116 may represent a plurality of network computers. For example, in one embodiment, the operations management server computer 116 may be distributed over a plurality of network computers and/or implemented using cloud architecture.

Moreover, the operations management server computer 116 is not limited to a particular configuration. Thus, the operations management server computer 116 may operate using a master/slave approach over a plurality of network computers, within a cluster, a peer-to-peer architecture, and/or any of a variety of other architectures.

In some embodiments, one or more data centers, such as a data center 118, may be communicatively coupled to the wireless network 110 and/or the network 111. In at least one of the various embodiments, the data center 118 may be a portion of a private data center, public data center, public cloud environment, or private cloud environment. In some embodiments, the data center 118 may be a server room/data center that is physically under the control of an organization. The data center 118 may include one or more enclosures of network computers, such as, an enclosure 120 and an enclosure 122.

The enclosure 120 and the enclosure 122 may be enclosures (e.g., racks, cabinets, or the like) of network computers and/or blade servers in the data center 118. In some embodiments, the enclosure 120 and the enclosure 122 may be arranged to include one or more network computers arranged to operate as operations management server computers, monitoring server computers (e.g., the operations management server computer 116, the monitoring server computer 114, or the like), storage computers, or the like, or combination thereof. Further, one or more cloud instances may be operative on one or more network computers included in the enclosure 120 and the enclosure 122.

The data center 118 may also include one or more public or private cloud networks. Accordingly, the data center 118 may comprise multiple physical network computers, interconnected by one or more networks, such as, networks similar to and/or the including network 111 and/or wireless network 110. The data center 118 may enable and/or provide one or more cloud instances (not shown). The number and composition of cloud instances may be vary depending on the demands of individual users, cloud network arrangement, operational loads, performance considerations, application needs, operational policy, or the like. In at least one of the various embodiments, the data center 118 may be arranged as a hybrid network that includes a combination of hardware resources, private cloud resources, public cloud resources, or the like.

As such, the operations management server computer 116 is not to be construed as being limited to a single environment, and other configurations, and architectures are also contemplated. The operations management server computer 116 may employ processes such as described below in conjunction with at least some of the figures discussed below to perform at least some of its actions.

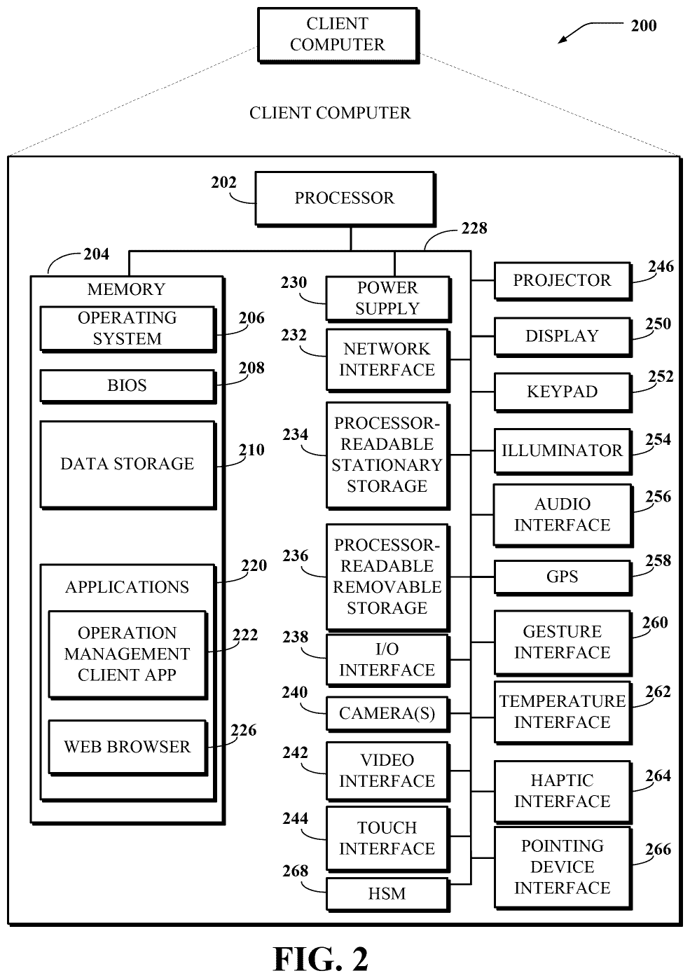

FIG. 2 shows one embodiment of a client computer 200. The client computer 200 may include more or less components than those shown in FIG. 2. The client computer 200 may represent, for example, at least one embodiment of mobile computers or client computers shown in FIG. 1.

The client computer 200 may include a processor 202 in communication with a memory 204 via a bus 228. The client computer 200 may also include a power supply 230, a network interface 232, an audio interface 256, a display 250, a keypad 252, an illuminator 254, a video interface 242, an input/output interface (i.e., an I/O interface 238), a haptic interface 264, a global positioning systems (GPS) receiver 258, an open-air gesture interface 260, a temperature interface 262, a camera 240, a projector 246, a pointing device interface 266, a processor-readable stationary storage device 234, and a non-transitory processor-readable removable storage device 236. The client computer 200 may optionally communicate with a base station (not shown), or directly with another computer. And in one embodiment, although not shown, a gyroscope may be employed within the client computer 200 to measure or maintain an orientation of the client computer 200.

The power supply 230 may provide power to the client computer 200. A rechargeable or non-rechargeable battery may be used to provide power. The power may also be provided by an external power source, such as an AC adapter or a powered docking cradle that supplements or recharges the battery.

The network interface 232 includes circuitry for coupling the client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. The network interface 232 is sometimes known as a transceiver, transceiving device, or network interface card (NIC).

The audio interface 256 may be arranged to produce and receive audio signals such as the sound of a human voice. For example, the audio interface 256 may be coupled to a speaker and microphone (not shown) to enable telecommunication with others or generate an audio acknowledgement for some action. A microphone in the audio interface 256 can also be used for input to or control of the client computer 200, e.g., using voice recognition, detecting touch based on sound, and the like.

The display 250 may be a liquid crystal display (LCD), gas plasma, electronic ink, light emitting diode (LED), Organic LED (OLED) or any other type of light reflective or light transmissive display that can be used with a computer. The display 250 may also include a touch interface 244 arranged to receive input from an object such as a stylus or a digit from a human hand, and may use resistive, capacitive, surface acoustic wave (SAW), infrared, radar, or other technologies to sense touch or gestures.

The projector 246 may be a remote handheld projector or an integrated projector that is capable of projecting an image on a remote wall or any other reflective object such as a remote screen.

The video interface 242 may be arranged to capture video images, such as a still photo, a video segment, an infrared video, or the like. For example, the video interface 242 may be coupled to a digital video camera, a web-camera, or the like. The video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

The keypad 252 may comprise any input device arranged to receive input from a user. For example, the keypad 252 may include a push button numeric dial, or a keyboard. The keypad 252 may also include command buttons that are associated with selecting and sending images.

The illuminator 254 may provide a status indication or provide light. The illuminator 254 may remain active for specific periods of time or in response to event messages. For example, when the illuminator 254 is active, it may backlight the buttons on the keypad 252 and stay on while the client computer is powered. Also, the illuminator 254 may backlight these buttons in various patterns when particular actions are performed, such as dialing another client computer. The illuminator 254 may also cause light sources positioned within a transparent or translucent case of the client computer to illuminate in response to actions.

Further, the client computer 200 may also comprise a hardware security module (i.e., an HSM 268) for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, the HSM 268 may be a stand-alone computer, in other cases, the HSM 268 may be arranged as a hardware card that may be added to a client computer.

The I/O 238 can be used for communicating with external peripheral devices or other computers such as other client computers and network computers. The peripheral devices may include an audio headset, display screen glasses, remote speaker system, remote speaker and microphone system, and the like. The I/O interface 238 can utilize one or more technologies, such as Universal Serial Bus (USB), Infrared, WiFi, WiMax, Bluetooth™, and the like.

The I/O interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the client computer 200.

The haptic interface 264 may be arranged to provide tactile feedback to a user of the client computer. For example, the haptic interface 264 may be employed to vibrate the client computer 200 in a particular way when another user of a computer is calling. The temperature interface 262 may be used to provide a temperature measurement input or a temperature changing output to a user of the client computer 200. The open-air gesture interface 260 may sense physical gestures of a user of the client computer 200, for example, by using single or stereo video cameras, radar, a gyroscopic sensor inside a computer held or worn by the user, or the like. The camera 240 may be used to track physical eye movements of a user of the client computer 200.

The GPS transceiver 258 can determine the physical coordinates of the client computer 200 on the surface of the earth, which typically outputs a location as latitude and longitude values. The GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the client computer 200 on the surface of the earth. It is understood that under different conditions, the GPS transceiver 258 can determine a physical location for the client computer 200. In at least one embodiment, however, the client computer 200 may, through other components, provide other information that may be employed to determine a physical location of the client computer, including for example, a Media Access Control (MAC) address, IP address, and the like.

Human interface components can be peripheral devices that are physically separate from the client computer 200, allowing for remote input or output to the client computer 200. For example, information routed as described here through human interface components such as the display 250 or the keypad 252 can instead be routed through the network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Bluetooth LE, Zigbee™ and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include a web browser application 226 that is configured to receive and to send web pages, web-based messages, graphics, text, multimedia, and the like. The client computer's browser application may employ virtually any programming language, including a wireless application protocol messages (WAP), and the like. In at least one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

The memory 204 may include RAM, ROM, or other types of memory. The memory 204 illustrates an example of computer-readable storage media (devices) for storage of information such as computer-readable instructions, data structures, program modules or other data. The memory 204 may store a BIOS 208 for controlling low-level operation of the client computer 200. The memory may also store an operating system 206 for controlling the operation of the client computer 200. It will be appreciated that this component may include a general-purpose operating system such as a version of UNIX, or LINUX™, or a specialized client computer communication operating system such as Windows Phone™, or IOS® operating system. The operating system may include, or interface with, a Java virtual machine module that enables control of hardware components or operating system operations via Java application programs.

The memory 204 may further include one or more data storage 210, which can be utilized by the client computer 200 to store, among other things, the applications 220 or other data. For example, the data storage 210 may also be employed to store information that describes various capabilities of the client computer 200. The information may then be provided to another device or computer based on any of a variety of methods, including being sent as part of a header during a communication, sent upon request, or the like. The data storage 210 may also be employed to store social networking information including address books, buddy lists, aliases, user profile information, or the like. The data storage 210 may further include program code, data, algorithms, and the like, for use by a processor, such as the processor 202 to execute and perform actions. In one embodiment, at least some of the data storage 210 might also be stored on another component of the client computer 200, including, but not limited to, the non-transitory processor-readable removable storage device 236, the processor-readable stationary storage device 234, or external to the client computer.

The applications 220 may include computer executable instructions which, when executed by the client computer 200, transmit, receive, or otherwise process instructions and data. The applications 220 may include, for example, an operations management client application 222. In at least one of the various embodiments, the operations management client application 222 may be used to exchange communications to and from the operations management server computer 116 of FIG. 1, the monitoring server computer 114 of FIG. 1, the application server computer 112 of FIG. 1, or the like. Exchanged communications may include, but are not limited to, queries, searches, messages, notification messages, events, alerts, performance metrics, log data, API calls, or the like, combination thereof.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more embodiments (not shown in the figures), the client computer 200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the client computer 200 may include a hardware microcontroller instead of a CPU. In at least one embodiment, the microcontroller may directly execute its own embedded logic to perform actions and access its own internal memory and its own external Input and Output Interfaces (e.g., hardware pins or wireless transceivers) to perform actions, such as System On a Chip (SOC), or the like.

FIG. 3 shows one embodiment of network computer 300 that may at least partially implement one of the various embodiments. The network computer 300 may include more or less components than those shown in FIG. 3. The network computer 300 may represent, for example, one embodiment of at least one EMB, such as the operations management server computer 116 of FIG. 1, the monitoring server computer 114 of FIG. 1, or an application server computer 112 of FIG. 1. Further, in some embodiments, the network computer 300 may represent one or more network computers included in a data center, such as, the data center 118, the enclosure 120, the enclosure 122, or the like.

As shown in the FIG. 3, the network computer 300 includes a processor 302 in communication with a memory 304 via a bus 328. The network computer 300 also includes a power supply 330, a network interface 332, an audio interface 356, a display 350, a keyboard 352, an input/output interface (i.e., an I/O interface 338), a processor-readable stationary storage device 334, and a processor-readable removable storage device 336. The power supply 330 provides power to the network computer 300.

The network interface 332 includes circuitry for coupling the network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. The network interface 332 is sometimes known as a transceiver, transceiving device, or network interface card (NIC). The network computer 300 may optionally communicate with a base station (not shown), or directly with another computer.

The audio interface 356 is arranged to produce and receive audio signals such as the sound of a human voice. For example, the audio interface 356 may be coupled to a speaker and microphone (not shown) to enable telecommunication with others or generate an audio acknowledgement for some action. A microphone in the audio interface 356 can also be used for input to or control of the network computer 300, for example, using voice recognition.

The display 350 may be a liquid crystal display (LCD), gas plasma, electronic ink, light emitting diode (LED), Organic LED (OLED) or any other type of light reflective or light transmissive display that can be used with a computer. The display 350 may be a handheld projector or pico projector capable of projecting an image on a wall or other object.

The network computer 300 may also comprise the I/O interface 338 for communicating with external devices or computers not shown in FIG. 3. The I/O interface 338 can utilize one or more wired or wireless communication technologies, such as USB™ Firewire™, WiFi, WiMax, Thunderbolt™, Infrared, Bluetooth™, Zigbee™, serial port, parallel port, and the like.

Also, the I/O interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the network computer 300. Human interface components can be physically separate from network computer 300, allowing for remote input or output to the network computer 300. For example, information routed as described here through human interface components such as the display 350 or the keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through a pointing device interface 358 to receive user input.

A GPS transceiver 340 can determine the physical coordinates of network computer 300 on the surface of the Earth, which typically outputs a location as latitude and longitude values. The GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the network computer 300 on the surface of the Earth. It is understood that under different conditions, the GPS transceiver 340 can determine a physical location for the network computer 300. In at least one embodiment, however, the network computer 300 may, through other components, provide other information that may be employed to determine a physical location of the client computer, including for example, a Media Access Control (MAC) address, IP address, and the like.

The memory 304 may include Random Access Memory (RAM), Read-Only Memory (ROM), or other types of memory. The memory 304 illustrates an example of computer-readable storage media (devices) for storage of information such as computer-readable instructions, data structures, program modules or other data. The memory 304 stores a basic input/output system (i.e., a BIOS 308) for controlling low-level operation of the network computer 300. The memory also stores an operating system 306 for controlling the operation of the network computer 300. It will be appreciated that this component may include a general-purpose operating system such as a version of UNIX, or LINUX™, or a specialized operating system such as Microsoft Corporation's Windows® operating system, or the Apple Corporation's IOS® operating system. The operating system may include, or interface with a Java virtual machine module that enables control of hardware components or operating system operations via Java application programs. Likewise, other runtime environments may be included.

The memory 304 may further include a data storage 310, which can be utilized by the network computer 300 to store, among other things, applications 320 or other data. For example, the data storage 310 may also be employed to store information that describes various capabilities of the network computer 300. The information may then be provided to another device or computer based on any of a variety of methods, including being sent as part of a header during a communication, sent upon request, or the like. The data storage 310 may also be employed to store social networking information including address books, buddy lists, aliases, user profile information, or the like. The data storage 310 may further include program code, instructions, data, algorithms, and the like, for use by a processor, such as the processor 302 to execute and perform actions such as those actions described below. In one embodiment, at least some of the data storage 310 might also be stored on another component of the network computer 300, including, but not limited to, the non-transitory media inside processor-readable removable storage device 336, the processor-readable stationary storage device 334, or any other computer-readable storage device within the network computer 300 or external to network computer 300. The data storage 310 may include, for example, models 312, operations metrics 314, events 316, or the like.

The applications 320 may include computer executable instructions which, when executed by the network computer 300, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. The applications 320 may be or include executable instructions, which can be loaded or copied, in whole or in part, from non-volatile memory to volatile memory to be executed by the processor 302. For example, the applications 320 can include instructions for performing some or all of the techniques of this disclosure. For example, the applications 320 can include software, tools, instructions or the like for generating smart incident status updates using generative artificial intelligence. In at least one of the various embodiments, one or more of the applications may be implemented as modules or components of another application. Further, in at least one of the various embodiments, applications may be implemented as operating system extensions, modules, plugins, or the like.

Furthermore, in at least one of the various embodiments, at least some of the applications 320 may be operative in a cloud-based computing environment. In at least one of the various embodiments, these applications, and others, that include the management platform may be executing within virtual machines or virtual servers that may be managed in a cloud-based based computing environment. In at least one of the various embodiments, in this context the applications may flow from one physical network computer within the cloud-based environment to another depending on performance and scaling considerations automatically managed by the cloud computing environment. Likewise, in at least one of the various embodiments, virtual machines or virtual servers dedicated to at least some of the applications 320 may be provisioned and de-commissioned automatically.

In at least one of the various embodiments, the applications may be arranged to employ geo-location information to select one or more localization features, such as, time zones, languages, currencies, calendar formatting, or the like. Localization features may be used in user-interfaces and well as internal processes or databases. Further, in some embodiments, localization features may include information regarding culturally significant events or customs (e.g., local holidays, political events, or the like) In at least one of the various embodiments, geo-location information used for selecting localization information may be provided by the GPS transceiver 340. Also, in some embodiments, geolocation information may include information providing using one or more geolocation protocol over the networks, such as, the wireless network 108 or the network 111.

Also, in at least one of the various embodiments, at least some of the applications 320, may be located in virtual servers running in a cloud-based computing environment rather than being tied to one or more specific physical network computers.

Further, the network computer 300 may also comprise hardware security module (i.e., an HSM 360) for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, the HSM 360 may be a stand-alone network computer, in other cases, the HSM 360 may be arranged as a hardware card that may be installed in a network computer.

Additionally, in one or more embodiments (not shown in the figures), the network computer 300 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the network computer may include a hardware microcontroller instead of a CPU. In at least one embodiment, the microcontroller may directly execute its own embedded logic to perform actions and access its own internal memory and its own external Input and Output Interfaces (e.g., hardware pins or wireless transceivers) to perform actions, such as System On a Chip (SOC), or the like.

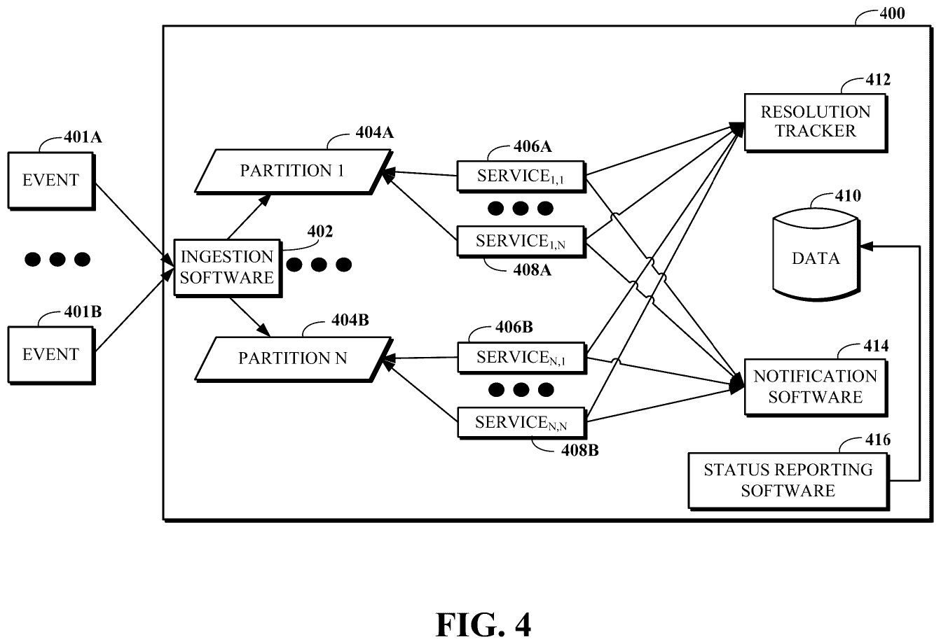

FIG. 4 illustrates a logical architecture of a system 400 for generating incident status reports. In at least one of the various embodiments, a system for automatically generating smart incident status updates may include various components. In this example, the system 400 includes an ingestion software 402, one or more partitions 404A-404B, one or more services 406A-406B and 408A-408B, a data store 410, a resolution tracker 412, a notification software 414, and a status reporting software 416.

One or more systems, such as monitoring systems, of one or more organizations may be configured to transmit events to the system 400 for processing. The system 400 may provide several services. A service may, for example, process an event and determine whether a downstream object (e.g., an incident) is to be triggered. As mentioned above, a received event may trigger an alert, which may trigger an incident, which in turn may cause notifications to be transmitted to responders.

A received event from an organization may include an indication of one or more services that are to operate on (e.g., process, etc.) the event. The indication of the service is referred to herein as a routing key. A routing key may be unique to a managed organization. As such, two events that are received from two different managed organizations for processing by the same service would include two different routing keys. A routing key may be unique to the service that is to receive and process an event. As such, two events associated with two different routing keys and received from the same managed organization for processing may be directed to (e.g., processed by) different services.

The ingestion software 402 may be configured to receive or obtain different types of events provided by various sources, here represented by events 401A, 401B. The ingestion software 402 may be configured to accept or reject received events. In an example, events may be rejected when events are received at a rate that is higher than a configured event-acceptance rate. If the ingestion software 402 accepts an event, the ingestion software 402 may place the event in a partition (such as one of the partitions 404A, 404B) for further processing. If an event is rejected, the event is not placed in a partition for further processing. The ingestion software may notify the sender of the event of whether the event was accepted or rejected. Grouping events into partitions can be used to enable parallel processing and/or scaling of the system 400 so that the system 400 can handle (e.g., process, etc.) more and more events and/or more and more organizations (e.g., additional events from additional organizations).

The ingestion software 402 may be arranged to receive the various events and perform various actions, including, filtering, reformatting, information extraction, data normalizing, or the like, or combination thereof, to enable the events to be stored (e.g., queued, etc.) and further processed. In at least one of the various embodiments, the ingestion software 402 may be arranged to normalize incoming events into a unified common event format. Accordingly, in some embodiments, the ingestion software 402 may be arranged to employ configuration information, including, rules, maps, dictionaries, or the like, or combination thereof, to normalize the fields and values of incoming events to the common event format. The ingestion software 402 may assign (e.g., associate, etc.) an ingested timestamp with an accepted event.

In at least one of the various embodiments, an event may be stored in a partition, such as one of the partition 404A or the partition 404B. A partition can be, or can be thought of, as a queue (e.g., a first-in-first-out queue) of events. FIG. 4 is shown as including two partitions (i.e., the partitions 404A and 404B). However, the disclosure is not so limited and the system 400 can include one or more than two partitions.

In an example, different services of the system 400 may be configured to operate on events of the different partitions. In an example, the same services (e.g., identical logic) may be configured to operate on the accepted events in different partitions. To illustrate, in FIG. 4, the services 406A and 408A process the events of the partition 404A, and the services 406B and 408B process the events of partition the 404B, where the service 406A and the service 406B execute the same logic (e.g., perform the same operations) of a first service but on different physical or virtual servers; and the service 408A and the service 408B execute the same logic of a second service but on different physical or virtual servers. In an example, different types of events may be routed to different partitions. As such, each of the services 406A-406B and 408A-408B may perform different logic as appropriate for the events processed by the service.

An (e.g., each) event, may also be associated with one or more services that may be responsible for processing the events. As such, an event can be said to be addressed or targeted to the one or more services that are to process the event. As mentioned above, an event can include or can be associated with a routing key that indicates the one or more services that are to receive the event for processing.

Events may be variously formatted messages that reflect the occurrence of events or incidents that have occurred in the computing systems or infrastructures of one or more managed organizations. Such events may include facts regarding system errors, warning, failure reports, customer service requests, status messages, or the like. One or more external services, at least some of which may be monitoring services, may collect events and provide the events to the system 400. Events as described above may be comprised of, or transmitted to the system 400 via, SMS messages, HTTP requests/posts, API calls, log file entries, trouble tickets, emails, or the like. An event may include associated metadata, such as, a title (or subject), a source, a creation time stamp, a status indicator, a region, more information, fewer information, other information, or a combination thereof, that may be tracked. In an example, the event data may be received as structured data, which may be formatted using JavaScript Object Notation (JSON), XML, or some other structured format. The metadata associated with an event is not limited in any way. The metadata included in or associated with an event can be whatever the sender of the event deems required.

In at least one of the various embodiments, a data store 410 may be arranged to store performance metrics, configuration information, or the like, for the system 400. In an example, the data store 410 may be implemented as one or more relational database management systems, one or more object databases, one or more XML databases, one or more operating system files, one or more unstructured data databases, one or more synchronous or asynchronous event or data buses that may use stream processing, one or more other suitable non-transient storage mechanisms, or a combination thereof.

Data related to events, alerts, incidents, notifications, other types of objects, or a combination thereof may be stored in the data store 410. For example, the data store 410 can include data related to resolved and unresolved alerts. For example, the data store 410 can include data identifying whether alerts are or are not acknowledged. For example, with respect to a resolved alert, the data store 410 can include information regarding the resolving entity that resolved the alert (and/or, equivalently, the resolving entity of the event that triggered the alert), the duration that the alert was active until it was resolved, other information, or a combination thereof. The resolving entity can be a responder (e.g., a human). The resolving entity can be an integration (e.g., automated system), which can indicate that the alert was auto-resolved. That the alert is auto-resolved can mean that the system 400 received, such as from the integration, an event indicating that a previous event, which triggered the alert, is resolved. The integration may be a monitoring system.

The data store 410 can be used to store, inter alia, incident data. An incident may be represented as an object in the data store 410. For brevity, an incident object is simply referred to as an incident. In an example, the incident data may be notes (textual or otherwise) entered in association with the incident by responders. The incident data may include an association to one or more responders, such as those assigned to the incident. The set of notes associated with an incident may be referred to as an incident timeline. In an example, at least some of the notes of the incident timeline may be programmatically obtained, by one or more components of the system 400, from other systems. The data store 410 can include data usable by the status reporting software 416 to generate incident status reports. The data usable by the status reporting software 416 can include template, training data, prompts, rules, and the like usable by the status reporting software 416 to configure a language model tool, as further described herein.

In at least one of the various embodiments, the resolution tracker 412 may be arranged to monitor the details regarding how events, alerts, incidents, other objects received, created, managed by the system 400, or a combination thereof are resolved. In some embodiments, this may include tracking incident and/or alert life-cycle metrics related to the events (e.g., creation time, acknowledgement time(s), resolution time, processing time,), the resources that are/were responsible for resolving the events, the resources (e.g., the responder or the automated process) that resolved alerts, and so on. The resolution tracker 412 can receive data from the different services that process events, alerts, or incidents. Receiving data from a service by the resolution tracker 412 encompasses receiving data directly from the service and/or accessing (e.g., polling for, querying for, asynchronously being notified of, etc.) data generated (e.g., set, assigned, calculated by, stored, etc.) by the service. The resolution tracker can receive (e.g., query for, read, etc.) data from the data store 410. The resolution tracker can write (e.g., update, etc.) data in the data store 410.

While FIG. 4 is shown as including one resolution tracker 412, the disclosure herein is not so limited and the system 400 can include more than one resolution tracker. In an example, different resolution trackers may be configured to receive data from services of one or more partitions. In an example, each partition may be associated with one resolution tracker. Other configurations or mappings between partitions, services, and resolution trackers are possible.

The notification software 414 may be arranged to generate notification messages for at least some of the accepted events. The notification messages may be transmitted to responders (e.g., responsible users, teams) or automated systems. The notification software 414 may select a messaging provider that may be used to deliver a notification message to the responsible resource. The notification software 414 may determine which resource is responsible for handling the event message and may generate one or more notification messages and determine particular message providers to use to send the notification message.

In at least one of the various embodiments, a scheduler (not shown) may determine which responder is responsible for handling an incident based on at least an on-call schedule and/or the content of the incident. The notification software 414 may generate one or more notification messages and determine a particular message provider to use to send the notification message. Accordingly, the selected message providers may transmit (e.g., communicate, etc.) the notification message to the responder. Transmitting a notification to a responder, as used herein, and unless the context indicates otherwise, encompasses transmitting the notification to a team or a group. In some embodiments, the message providers may generate an acknowledgment message that may be provided to system 400 indicating a delivery status of the notification message (e.g., successful or failed delivery).

In at least one of the various embodiments, the notification software 414 may determine the message provider based on a variety of considerations, such as, geography, reliability, quality-of-service, user/customer preference, type of notification message (e.g., SMS or Push Notification, or the like), cost of delivery, or the like, or combination thereof. In at least one of the various embodiments, various performance characteristics of each message provider may be stored and/or associated with a corresponding provider performance profile. Provider performance profiles may be arranged to represent the various metrics that may be measured for a provider. Also, provider profiles may include preference values and/or weight values that may be configured rather than measured.

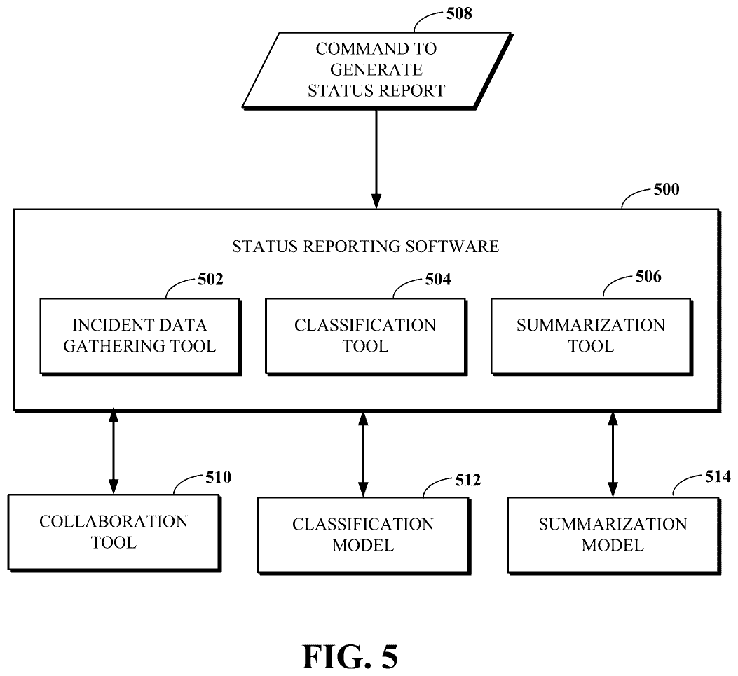

The status reporting software 416 can be used to generate status reports for incidents. At a high level, the status reporting software 416 uses incident data, training data, and prompts as inputs to a language model, such as a generative artificial intelligence model or a large language model, to obtain incident status reports. The status reporting software 416 is further described with respect to FIG. 5.

In at least one of the various embodiments, the system 400 may include various user-interfaces or configuration information (not shown) that enable organizations to establish how events should be resolved. Accordingly, an organization may define rules, conditions, priority levels, notification rules, escalation rules, routing keys, or the like, or combination thereof, that may be associated with different types of events. For example, some events (e.g., of the frequent type) may be informational rather than associated with a critical failure. Accordingly, an organization may establish different rules or other handling mechanics for the different types of events. For example, in some embodiments, critical events (e.g., rare or novel events) may require immediate (e.g., within the target lag time) notification of a response user to resolve the underlying cause of the event. In other cases, the events may simply be recorded for future analysis.

In an example, one or more of the user interfaces may be used to associate runbooks with certain types of objects. A runbook can include a set of actions that can implement or encapsulate a standard operating procedure for responding to (e.g., remediating, etc.) events of certain types. Runbooks can reduce toil. Toil can be defined as the manual or semi-manual performance of repetitive tasks. Toil can reduce the productivity of responders (e.g., operations engineers, developers, quality assurance engineers, business analysts, project managers, and the like) and prevents them from performing other value-adding work. In an example, a runbook may be associated with a template. As such, if an object matches the template, then the tasks of the runbook can be performed (e.g., executed, orchestrated, etc.) according to the order, rules, and/or workflow specified in the runbook. In another example, the runbook can be associated with a type. As such, if an object is identified as being of a certain type, then the tasks of the runbook associated with the certain type can be performed. A runbook can be assembled from predefined actions, custom actions, other types of actions, or a combination thereof.

In an example, one or more of the user interfaces may be used by responders to obtain information regarding objects and/or groups of objects. For example, a responder can use one of the user interfaces to obtain information regarding incidents assigned to or acknowledged by the responder. A user interface can be used to obtain information about an incident including the events (i.e., the group of events) associated with the incident. In an example, the responder can use the user interface to obtain information from the system 400 regarding the reason(s) a particular event was added to the group of events.

At least one of the services 406A-406B and 408A-408B may be configured to trigger alerts. A service can also trigger an incident from an alert, which in turn can cause notifications to be transmitted to one or more responders.

FIG. 5 is a block diagram of example functionality of a status reporting software 500. The status reporting software 500 may be the status reporting software 416 of FIG. 4. The status reporting software 500 includes tools, such as programs, subprograms, functions, routines, subroutines, operations, executable instructions, and/or the like for, inter alia and as further described, interacting with one or more language models to generate incident status reports from incident data. As mentioned above, the status reporting software 500 uses a two-step process to generate incident status reports, as further described herein. The first step may be understood to perform tasks such as: does the incident data include information related to a particular reporting criterion? In the second step, if the answer is Yes, then a summary of those incident data related to the particular reporting criterion are included in the incident status report.

At least some of the tools of the status reporting software 500 can be implemented as respective software programs that may be executed by one or more computing devices, such as the network computer 300 of FIG. 3. A software program can include machine-readable instructions that may be stored in one or more memories such as one or more of the memory 304, and that, when executed by one or more processors, such as the processor 302 of FIG. 3, may cause the computing device to perform the instructions of the software program.

As shown, the status reporting software 500 includes an incident data gathering tool 502, a classification tool 504, and a summarization tool 506. In some implementations, the status reporting software 500 can include more or fewer tools. In some implementations, some of the tools may be combined, some of the tools may be split into more tools, or a combination thereof.

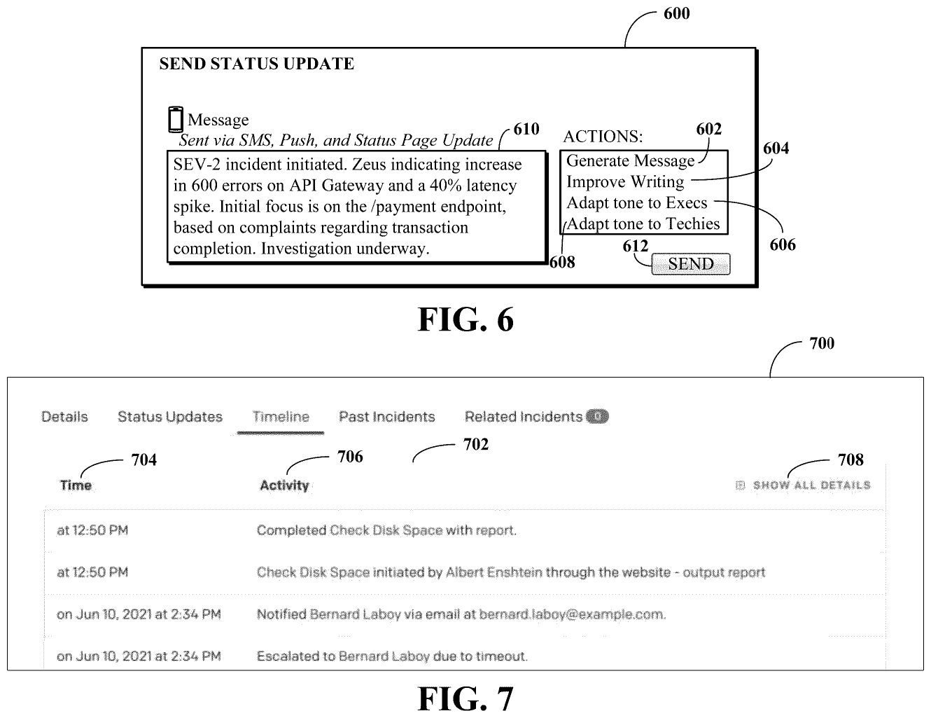

The status reporting software 500 receives a command 508 to generate a status report. In an example, the command may be received from a responder. The responder may cause the command to be received by the status reporting software 500 via a user interface. The command may include one or more parameters, as further described with respect to FIG. 6. In another example, the command may be received based on or from an automated schedule. For example, a workflow of the system 400 of FIG. 4 may be configured to cause incident status reports to be generated and transmitted at a specified frequency or based on triggering criteria. In an example, the command may include or be associated with a reporting time window. For example, the incident status report may be generated based on new incident data accumulated since the last generated status report. For example, the incident status report may be generated based on incident data accumulated since the start (e.g., instantiation) of the incident.

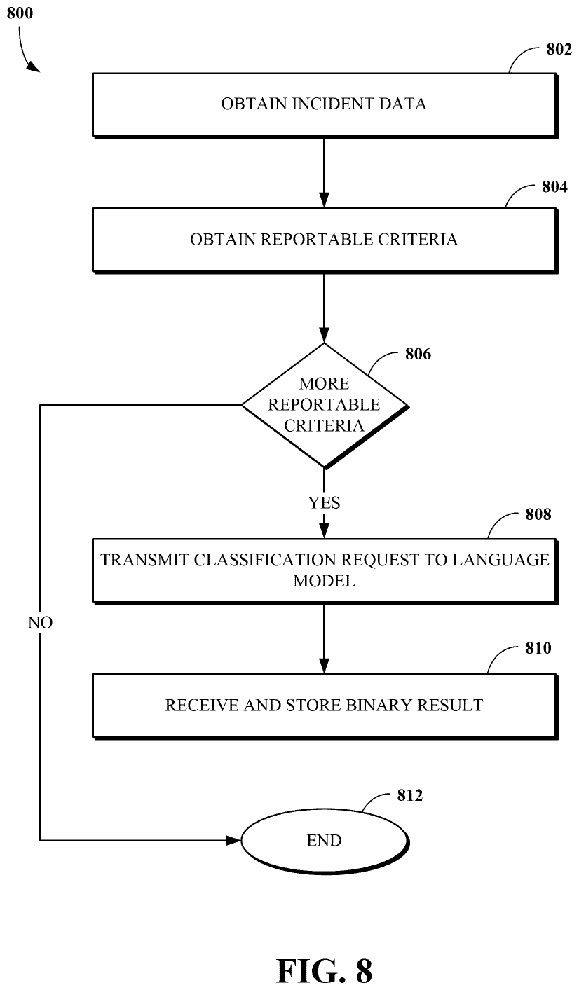

In response to receiving the command to generate the status report, the incident data gathering tool 502 may collect incident data usable for generating the status report. The incident data may be collected based on the reporting time window. Collecting incident data can mean or include querying for and receiving the incident data. The incident data gathering tool 502 may collect incident data from a data store, such as the data store 410 of FIG. 4. As such, the incident information can include incident timeline data. Timeline data is illustrated with respect to FIG. 7.

As can be appreciated, a myriad of tools can be used by responders throughout their day and in the process of resolving incidents. At least some of such tools can be broadly described as collaboration tools (such as a collaboration tool 510). Such collaboration tools may include an email tool, a messaging tool, a team workgroup tool, or the like. In some situations, a dedicated, incident-specific virtual chat room may be associated with an incident. Other tools usable by responders are possible. Regardless, the incident data gathering tool 502 can query for and obtain incident specific data from such tools. The obtained incident data may include information related to actions taken by responders, such as assigning tasks, assigning roles, providing updates, and the like. The obtained incident information may include chat messages exchanged between responders and others regarding the incident.

Additionally, the incident data gathering tool 502 can query for and obtain information related to the incident from other tools, such as a document management tool, a ticketing system, a knowledge base, or other tools. More generally, the collected incident data can include any data, electronically obtained from any system, tool, or software and are usable for generating incident status reports.

After collecting the incident data, the classification tool 504 uses a set of classifiers (which may be one or more classifiers, such as a classification model 512) to identify which of reportable criteria are described or included in the collected incident data. Once incident data is compiled (e.g., collected), the classification tool 504 applies a set of language model classifiers. Applying a language model classifier can be understood to mean that the classification tool 504 transmits a request to a classifier (e.g., the classification model 512) to perform a classification task. The classification tool 504 prompts the classifier to perform a binary classification task. That is the classifier returns a YES/No, 0/1, TRUE/FALSE, or the like answer. At a high level, a classification request transmitted by the classification tool 504 with respect to a reportable criterion C and a set of incident data D essentially states, ‘does any of D describe/is about/include the reportable criterion C?’.

There can be different sets of reportable criteria. Given a request to generate an incident status report, one of the sets of the reportable criteria can be selected based on the request (or the request context). To illustrate, one set of reportable criteria may be associated with incidents that impact more than 5000 users, another set of reportable criteria may be associated with cyber-security related incidents, yet another set of reportable criteria may be associated with a response to a natural disaster. Table I illustrates one, non-limiting, example of a set of reportable criteria. Again, other sets of reportable criteria are possible.

TABLE I
EXAMPLE REPORTABLE CRITERIA

Starting investigating an incident
Customer Impact
Identify the root-cause of an outage
Found a fix and monitoring if it worked
Anytime the severity of an incident changes
The incident is resolved

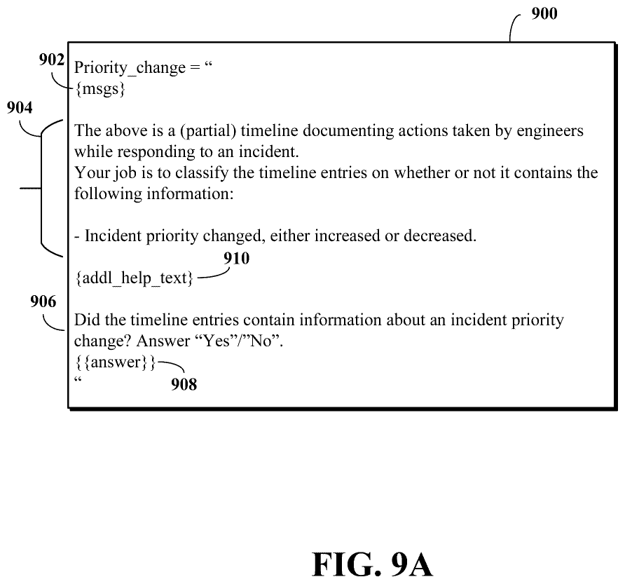

Each of the language model classifiers can be trained to “sift through” the collected incident information and identify if any correlates with a particular reportable criterion. These reportable criteria can be or include error codes, system failures, specific impacts on technical operations or customer experience, or other reportable criteria. By applying these classifiers, incident status reports can be focused to the specific, pertinent information that may be included in the incident information, as further with respect to the summarization tool 506. The operations of the classification tool 504 are further described with respect to FIG. 8.

The summarization tool 506 obtains a status report based on the identified reportable criteria. The summarization tool 506 transmits a summarization request to a language model, such a summarization model 514, to obtain the status report. The summarization request includes instructions to the language model to use the identified reportable criteria. Said another way, the summarization tool 506 causes the summarization model 514 to extract a summary from the incident information where the summary is exclusively focused on the identified reportable criteria. As such, the summarization tool 506 can be said to obtain the status report using only the subset of the incident information that correspond to the reportable criteria confirmed to be present in the collected incident information. This targeted approach eliminates unnecessary noise and clutter, ensuring that the incident status report is clear, concise, and contains only the most pertinent information.

In an example, the summarization tool 506 can include style criteria in the summarization request. The summarization tool 506 uses one or more of the style criteria to obtain a customized incident report status that is based on context, audience, communication protocol, or other style criteria. The style criteria can be or include one or more of the style criteria shown in Table II. The style criteria shown in Table II relate to anonymity (which may be used to maintain confidentiality and privacy), social media metatags (which may be used to maintains a formal tone), audience appropriateness (which may be used to enable understandability by and appropriateness for intended recipients.), character limits (which may be used to ensure that key points of the incident are communicated effectively). More, fewer, or other style criteria are possible.

TABLE II
STYLE CRITERIA

Do not mention anyone's name
Do not include social media metatags, such as #IncidentResponse
Should be geared towards a particular audience
Should be limited to 250 characters

Each of the style criteria may be associated with rules resolvable by the summarization tool 506 prior to the transmission of the summarization request. To illustrate, and without limitations, with respect to the audience appropriateness criterion, a resolvable rule may be “<%=assigns[:audience]∥“a business audience” %>,” which causes the summarization tool 506 to insert the value of the variable “audience,” if it is assigned; if the variable “audience” is nil or false, then the string “a business audience” is used instead. While not specifically mentioned with respect to reportable criteria, reportable criteria can also include resolvable rules.

FIG. 6 illustrates an example of a user interface 600 for causing incident summary reports to be generated. The user interface 600 can be available to a responder with respect to a particular incident (not specifically shown). The user interface 600 can be generated by the system 400 of FIG. 4 and can be displayed, such as in the form of a web page (or application) viewable or usable via a web browser, such as the web browser 226 of FIG. 2.

The user interface 600 includes commands 602-606 usable for generating incident status reports. A command 602, when invoked by the responder, causes the status reporting software 500 to generate an incident status report, as described above. The status report generated by the status reporting software 500 can be added to (e.g., displayed in) a field 610. The field 610 can be editable so that the responder can further refine or edit the status report.

The command 604, when invoked by the responder, causes the status reporting software 500 to transmit the text included in the field 610 to a language model, such as the summarization model 514 of FIG. 5 to refine the text. To illustrate, the responder may type an initial status update in the field 610 and, via the command 604, can cause the initial status update to be re-written by the language model. The language model may correct grammatical or typographical errors in the text.

The command 606, when invoked by the responder, causes to the text included in the field 610 to be re-written (e.g., adapted) to an execute or business audience; whereas the command 608, when invoked by the responder, causes to the text included in the field 610 to be re-written (e.g., adapted) to a technical audience. A command 612, when invoked by the responder, causes a message that includes the text of the field 610 to be transmitted to stakeholders associated with the incident.

FIG. 7 illustrates an example of a portion 700 of a user interface of an incident timeline associated with an incident. The incident timeline includes activities undertaken with respect to or other associated with the incident. The activities can be stored and retrieved from a data store, such as the data store 410 of FIG. 4. In the portion 700, the activities are shown as a list of rows in a table 702. However, other arrangements are possible. The table 702 includes a column 704 that shows time stamps of the respective activities of a column 706. The column 706 may only show summaries (e.g., a titles) of the listed activities. A control 708 may be used to obtain further detail with respect to one or more of the listed activities. That is, by invoking the control 708, rows may be expanded to show more data regarding the activities.

FIG. 8 is a flowchart of a technique 800 for determining which reportable criteria are included in incident data. The technique 800 can be implemented by a classification tool, such as the classification tool 504 of FIG. 5. The technique 800 can be executed using computing devices, such as the systems, hardware, and software described with respect to FIGS. 1-7. The technique 800 can be performed, for example, by executing a machine-readable program or other computer-executable instructions, such as routines, instructions, programs, or other code. The steps, or operations, of the technique 800, or another technique, method, process, or algorithm described in connection with the implementations disclosed herein can be implemented directly in hardware, firmware, software executed by hardware, circuitry, or a combination thereof.

At 802, incident data are obtained. For example, the incident information can be obtained from the incident data gathering tool 502 of FIG. 5. At 804, a list of reportable criteria is obtained. For example, the technique 800 may retrieve the list of reportable criteria from a data store. The list of reportable criteria may be based on the incident metadata (e.g., incident type). The list of reportable criteria may be based on one or more intended recipients of incident reports. To illustrate, different lists of reportable criteria may be associated with executives, internal stakeholder, external stakeholders, management personnel of the responder, a cross functional team, and so on.

For each of the reportable criteria of the set of reportable criteria, the technique 800 performs steps 808-810. As such, at 808, the technique 800 determines whether there are more reportable criteria to process. If so, the next reportable criteria is used and the technique 800 moves to 808. If not, the technique 800 ends at 812.

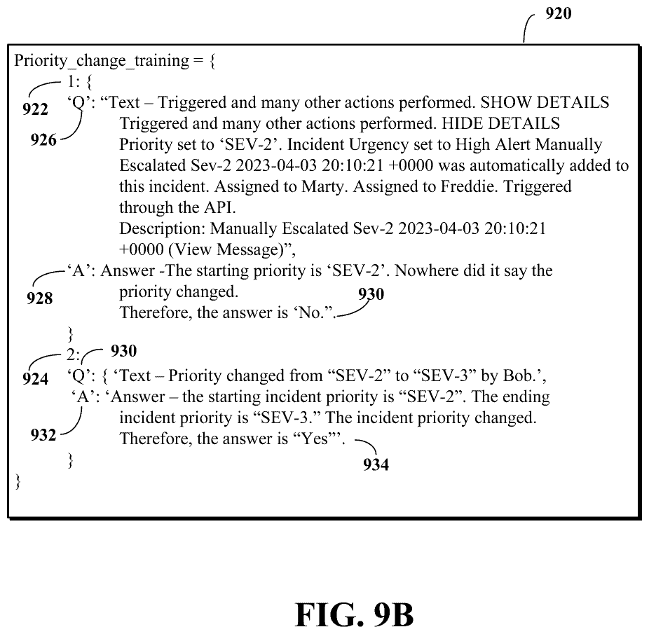

At 808, a classification request that includes the incident data and the reportable criterion are transmitted to a language model classifier. The classifier is prompted, via the classification request and as illustrated with respect to FIGS. 9A-9B, to return a binary decision indicating whether the incident information includes information related to or descriptive of the reportable criterion. At 810, a binary result with respect to the reportable criterion is received and stored for later use, such as by the summarization tool 506.

FIG. 9A illustrates an example 900 of a template of a classification request transmitted to a classifier with respect to a reportable criterion; specifically with respect to the “Anytime the severity of an incident changes” reportable criterion of Table I. The technique 800 replaces a placeholder 902 with the incident data prior to transmitting the request to the classifier. A task descriptor 904 describes, to the classifier, the task that the classifier is to perform. A question 906 includes a specific classification request and desired answer format expected from the classifier. The classifier replaces an answer placeholder 908 with its answer.

Depending on the reportable criterion, the classifier may not be able to perform the classification task without further training. Thus, the classification request may include training data for the classifier, which the classifier uses in order to learn to perform the classification task. As such, a field 910 can be replaced by training data.

FIG. 9B illustrates an example 920 of training data usable with a reportable criterion (e.g., the “Anytime the severity of an incident changes” reportable criterion of Table I). The example 920 includes two training samples: a first sample 922 and a second sample 924. However, more or fewer training samples can be included. Each of the training samples 922 and 924 includes respective training incident information 926 and 930, respective training deduction steps 928 and 932, and training final results 930 and 934. The classifier learns to apply the training deduction steps to incident information to output a final result.

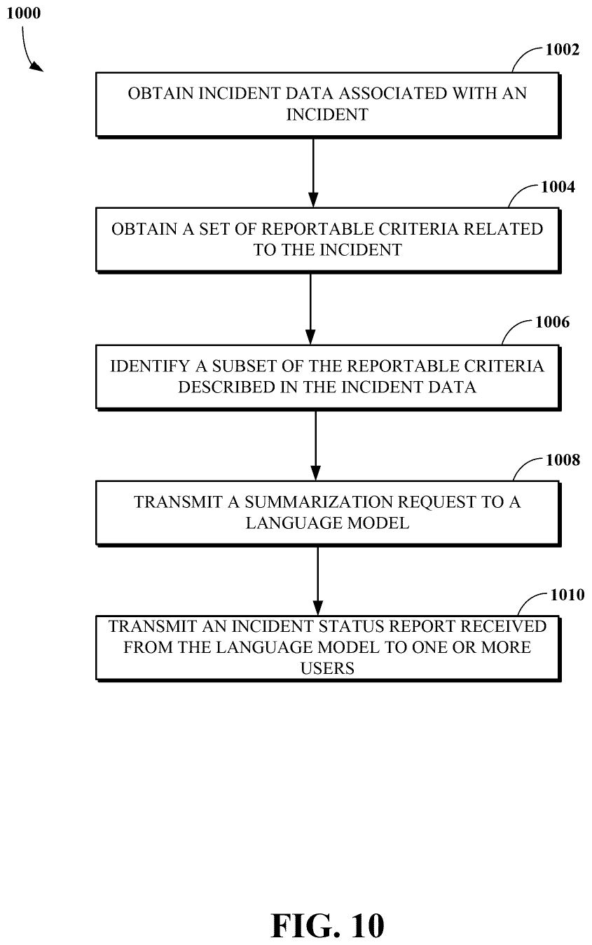

FIG. 10 is a flowchart of a technique 1000 for obtaining incident status reports. The technique 1000 can be implemented by a status reporting software, such as the status reporting software 500 of FIG. 5. The technique 1000 can be executed using computing devices, such as the systems, hardware, and software described with respect to FIGS. 1-9B. The technique 1000 can be performed, for example, by executing a machine-readable program or other computer-executable instructions, such as routines, instructions, programs, or other code. The steps, or operations, of the technique 1000, or another technique, method, process, or algorithm described in connection with the implementations disclosed herein can be implemented directly in hardware, firmware, software executed by hardware, circuitry, or a combination thereof.

At 1002, incident data associated with an incident are obtained. The incident data can be obtained such as described with respect to the incident data gathering tool 502 of FIG. 5. At 1004, a set of reportable criteria related to the incident are obtained. The set of reportable criteria can be as described above with respect to the classification tool 504.

At 1006, one or more classifiers are used to identify a subset of the reportable criteria described in the incident data. The subset of the reportable criteria can be identified as described with respect to the technique 800 of FIG. 8. As such, the reportable criteria can include data relating to whether the incident is under investigation, a level of customer impact of the incident, a root cause of the incident, whether a fix for the incident is identified, a change in severity of the incident, or whether the incident is resolved. Identifying, using the one or more classifiers, the subset of the reportable criteria described in the incident data can include receiving from one of the classifiers a binary indication of whether a reportable criterion of the reportable criteria is included in the incident data.

The one of the classifiers can be trained to identify whether the incident data include the reportable criterion by indicating to the one or more classifiers that first training data transmitted to the one of the classifiers include the reportable criterion and that second training data transmitted to the one of the classifiers do not include the reportable criterion. In an example, the training data can generally be as described with respect to FIG. 9B.

At 1008, a summarization request is transmitted to a language model. The summarization request can include the subset of the reportable criteria and the incident data. The summarization request can be as described with respect to, and can be transmitted by, the summarization tool 506 of FIG. 5.

At 1010, an incident status report received from the language model is transmitted to one or more users (e.g., stakeholders).

As described above, and in an example, the summarization request can include a style criterion. The style criterion can indicate whether the one or more users are technical users or non-technical users. The style criterion can indicate that the language model is to limit the incident status report to a maximum number of words included in the style criterion. The style criterion can indicate that the language model is to anonymize the incident status report based on the incident data. The style criterion can indicate that the language model is to exclude, from the incident status report, social media tags included in the incident data.

For simplicity of explanation, the techniques 800 and 1000 of FIGS. 8 and 10, respectively, are each depicted and described herein as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The disclosure presented herein may be considered in view of the following clauses.

Example Clause A: A method, comprising: obtaining incident data associated with an incident; obtaining a set of reportable criteria related to the incident; identifying, using one or more classifiers, a subset of the reportable criteria described in the incident data; transmitting a summarization request to a language model, wherein the summarization request includes the subset of the reportable criteria and the incident data; and transmitting an incident status report received from the language model in response to the summarization request to one or more users.

Example Clause B: The method of Example Clause A, wherein identifying, using the one or more classifiers, the subset of the reportable criteria described in the incident data comprises: receiving from one of the classifiers a binary indication of whether a reportable criterion of the reportable criteria is included in the incident data.

Example Clause C: The method of Example Clause A or Example Clause B, further comprising: training the one of the classifiers to identify whether the incident data include the reportable criterion by indicating to the one or more classifiers that first training data transmitted to the one of the classifiers include the reportable criterion and that second training data transmitted to the one of the classifiers do not include the reportable criterion.

Example Clause D: The method of any one of Example Clauses A-C, wherein the reportable criteria include data relating to whether the incident is under investigation, a level of customer impact of the incident, a root cause of the incident, whether a fix for the incident is identified, a change in severity of the incident, or whether the incident is resolved.

Example Clause E: The method of any one of Example Clauses A-D, wherein the summarization request includes a style criterion.

Example Clause F: The method of any one of Example Clauses A-E, wherein the style criterion indicates whether the one or more users are technical users.

Example Clause G: The method of any one of Example Clauses A-F, wherein the style criterion indicates that the language model is to limit the incident status report to a maximum number of words included in the style criterion.

Example Clause H: A system, comprising: one or more memories; and one or more processors, the one or more processors configured to execute instructions stored in the memory to: obtain incident data associated with an incident; obtain a set of reportable criteria related to the incident; identify, using one or more classifiers, a subset of the reportable criteria described in the incident data; transmit a summarization request to a language model, wherein the summarization request includes the subset of the reportable criteria and the incident data; and transmit an incident status report received from the language model in response to the summarization request to one or more users.

Example Clause I: The system of Example Clause H, wherein to identify, using the one or more classifiers, the subset of the reportable criteria described in the incident data comprises to: receive from one of the classifiers a binary indication of whether a reportable criterion of the reportable criteria is included in the incident data.

Example Clause J: The system of Example Clause H or Example Clause I, wherein the one or more processors are further configured to execute instructions stored in the one or more memories to: transmit, to the one or more classifiers, training data usable by the one of the classifiers in identifying whether the incident data include the reportable criterion, wherein the training data includes first training data that include the reportable criterion and second training data that do not include the reportable criterion.

Example Clause K: The system of any one of Example Clauses H-J, wherein the reportable criteria include data relating to at least one of whether the incident is under investigation, a level of customer impact of the incident, a root cause of the incident, whether a fix for the incident is identified, a change in severity of the incident, or whether the incident is resolved.

Example Clause L: The system of any one of Example Clauses H-K, wherein the summarization request includes a style criterion.

Example Clause M: The system of any one of Example Clauses H-L, wherein the style criterion indicates that the language model is to anonymize the incident status report based on the incident data.

Example Clause N: The system of any one of Example Clauses H-M, wherein the style criterion indicates that the language model is to exclude, from the incident status report, social media tags included in the incident data.

Example Clause O: A non-transitory computer readable medium storing instructions operable to cause one or more processors to perform operations comprising: obtaining incident data associated with an incident; obtaining a set of reportable criteria related to the incident; identifying, using one or more classifiers, a subset of the reportable criteria described in the incident data; transmitting a summarization request to a language model, wherein the summarization request includes the subset of the reportable criteria and the incident data; and transmitting an incident status report received from the language model in response to the summarization request to one or more users.

Example Clause P: The non-transitory computer readable medium of Example Clause O, wherein identifying, using the one or more classifiers, the subset of the reportable criteria described in the incident data comprises: receiving from one of the classifiers a binary indication of whether a reportable criterion of the reportable criteria is included in the incident data.

Example Clause Q: The non-transitory computer readable medium of Example Clause O or Example Clause P, wherein the operations further comprise: transmitting, to the one or more classifiers, training data usable by the one of the classifiers in identifying whether the incident data include the reportable criterion, wherein the training data includes first training data that include the reportable criterion and second training data that do not include the reportable criterion.

Example Clause R: The non-transitory computer readable medium of any one of Example Clauses O-Q, wherein the reportable criteria include data relating to at least one of whether the incident is under investigation, a level of customer impact of the incident, a root cause of the incident, whether a fix for the incident is identified, a change in severity of the incident, or whether the incident is resolved.

Example Clause S: The non-transitory computer readable medium of any one of Example Clauses O-R, wherein the summarization request includes a style criterion.

Example Clause T: The non-transitory computer readable medium of any one of Example Clauses O-S, wherein the style criterion includes a first style criterion indicating whether the one or more users are non-technical users and a second style criterion indicating that the language model is to limit the incident status report to a maximum number of words indicated by the style criterion.

The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example embodiments, the following terms are also used herein according to the corresponding meaning, unless the context clearly dictates otherwise.

As used herein the term, “software” refers to logic embodied in hardware or software instructions, which can be written in a programming language, such as C, C++, Objective-C, COBOL, Java™, PUP, Perl, JavaScript, Ruby, VBScript, Microsoft .NET™ languages such as C#, and/or the like. A software may be compiled into executable programs or written in interpreted programming languages. Software may be callable from other software or from themselves. Software described herein refer to one or more logical modules that can be merged with other software or applications, or can be divided into sub-software or tools. The software can be stored in non-transitory computer-readable medium or computer storage devices and be stored on and executed by one or more general purpose computers, thus creating a special purpose computer configured to provide the software.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
obtaining incident data associated with an incident;
obtaining a set of reportable criteria related to the incident;
identifying, using one or more classifiers, a subset of the reportable criteria described in the incident data;
transmitting a summarization request to a language model, wherein the summarization request includes the subset of the reportable criteria and the incident data; and
transmitting an incident status report received from the language model in response to the summarization request to one or more users.

2. The method of claim 1, wherein identifying, using the one or more classifiers, the subset of the reportable criteria described in the incident data comprises:
receiving from one of the classifiers a binary indication of whether a reportable criterion of the reportable criteria is included in the incident data.

3. The method of claim 2, further comprising:
training the one of the classifiers to identify whether the incident data include the reportable criterion by indicating to the one or more classifiers that first training data transmitted to the one of the classifiers include the reportable criterion and that second training data transmitted to the one of the classifiers do not include the reportable criterion.

4. The method of claim 1, wherein the reportable criteria include data relating to whether the incident is under investigation, a level of customer impact of the incident, a root cause of the incident, whether a fix for the incident is identified, a change in severity of the incident, and whether the incident is resolved.

5. The method of claim 1, wherein the summarization request includes a style criterion.

6. The method of claim 5, wherein the style criterion indicates whether the one or more users are technical users.

7. The method of claim 5, wherein the style criterion indicates that the language model is to limit the incident status report to a maximum number of words included in the style criterion.

8. A system, comprising:
one or more memories; and
one or more processors, the one or more processors configured to execute instructions stored in the memory to:
obtain incident data associated with an incident;
obtain a set of reportable criteria related to the incident;
identify, using one or more classifiers, a subset of the reportable criteria described in the incident data;
transmit a summarization request to a language model, wherein the summarization request includes the subset of the reportable criteria and the incident data; and
transmit an incident status report received from the language model in response to the summarization request to one or more users.

9. The system of claim 8, wherein to identify, using the one or more classifiers, the subset of the reportable criteria described in the incident data comprises to:
receive from one of the classifiers a binary indication of whether a reportable criterion of the reportable criteria is included in the incident data.

10. The system of claim 9, wherein the one or more processors are further configured to execute instructions stored in the one or more memories to:
transmit, to the one or more classifiers, training data usable by the one of the classifiers in identifying whether the incident data include the reportable criterion, wherein the training data includes first training data that include the reportable criterion and second training data that do not include the reportable criterion.

11. The system of claim 8, wherein the reportable criteria include data relating to at least one of whether the incident is under investigation, a level of customer impact of the incident, a root cause of the incident, whether a fix for the incident is identified, a change in severity of the incident, or whether the incident is resolved.

12. The system of claim 8, wherein the summarization request includes a style criterion.

13. The system of claim 12, wherein the style criterion indicates that the language model is to anonymize the incident status report based on the incident data.

14. The system of claim 12, wherein the style criterion indicates that the language model is to exclude, from the incident status report, social media tags included in the incident data.

15. A non-transitory computer readable medium storing instructions operable to cause one or more processors to perform operations comprising:
obtaining incident data associated with an incident;
obtaining a set of reportable criteria related to the incident;
identifying, using one or more classifiers, a subset of the reportable criteria described in the incident data;
transmitting a summarization request to a language model, wherein the summarization request includes the subset of the reportable criteria and the incident data; and
transmitting an incident status report received from the language model in response to the summarization request to one or more users.

16. The non-transitory computer readable medium of claim 15, wherein identifying, using the one or more classifiers, the subset of the reportable criteria described in the incident data comprises:
receiving from one of the classifiers a binary indication of whether a reportable criterion of the reportable criteria is included in the incident data.

17. The non-transitory computer readable medium of claim 16, wherein the operations further comprise:
transmitting, to the one or more classifiers, training data usable by the one of the classifiers in identifying whether the incident data include the reportable criterion, wherein the training data includes first training data that include the reportable criterion and second training data that do not include the reportable criterion.

18. The non-transitory computer readable medium of claim 15, wherein the reportable criteria include data relating to at least one of whether the incident is under investigation, a level of customer impact of the incident, a root cause of the incident, whether a fix for the incident is identified, a change in severity of the incident, or whether the incident is resolved.

19. The non-transitory computer readable medium of claim 15, wherein the summarization request includes a style criterion.

20. The non-transitory computer readable medium of claim 19, wherein the style criterion includes a first style criterion indicating whether the one or more users are non-technical users and a second style criterion indicating that the language model is to limit the incident status report to a maximum number of words indicated by the style criterion.
